(19) United States
(12) Patent Application Publication
(10) Pub. No.: US 2012/0192414 A1
(43) Pub. Date: Aug. 2, 2012

(54) ADJUSTABLE PREPARATION TOOL AND METHOD OF USE THEREOF

(75) Inventors: Noah Montena, Syracuse, NY (US); Christopher P. Natoli, Fulton, NY (US); Adam Thomas Nugent, Cicero, NY (US)

(73) Assignee: JOHN MEZZALINGUA ASSOCIATES, INC., East Syracuse, NY (US)

(21) Appl. No.: 13/338,977

(22) Filed: Dec. 28, 2011

Related U.S. Application Data
(60) Provisional application No. 61/438,092, filed on Jan. 31, 2011.

(51) Int. Cl. H01B 13/20; B23P 19/00

(52) U.S. Cl. 29/828; 29/745

(57) ABSTRACT

Disclosed herein is a coaxial cable preparation tool that includes a body and a cavity extending from the body configured to accommodate insertion of a coaxial cable therein. A blade attached to the body and positionable in the cavity, the blade configured to cut the coaxial cable when the body is rotated with respect to the coaxial cable. A circumferential adjustment mechanism within the cavity configured to adjust a gripping circumference within the cavity for gripping an outer jacket of the coaxial cable. Further disclosed is a method of preparing a coaxial cable that includes inserting the coaxial cable into a cavity of a coaxial cable preparation tool and adjusting a gripping circumference within the cavity of the coaxial cable preparation tool. The gripping circumference is configured to grip an outer jacket of the coaxial cable. The adjusting is accomplished by the inserting of the coaxial cable into the cavity.

### CROSS REFERENCE TO RELATED APPLICATIONS

This application claims priority to U.S. Provisional Patent Application to Montena et al., entitled “ADJUSTABLE DEPTH PREP TOOL,” Ser. No. 61/438,092, filed Jan. 31, 2011 the disclosure of which is hereby incorporated entirely herein by reference.

### FIELD OF THE INVENTION

The subject matter disclosed herein relates generally to preparation tools for coaxial cables. More particularly, this invention provides for an adjustable preparation tool for coaxial cables of various diameters, and method of use thereof.

### BACKGROUND OF THE INVENTION

Coaxial cables are used as a transmission line for radio frequency signals for applications including but not limited to various communications networks. Many different types of coaxial cables exist having varying impedances and diameters. Coaxial cables may be, for example, 50 ohm impedance cables or 75 ohm impedance cables. These coaxial cables typically include an outer plastic jacket surrounding at least one outer conductor, both of which further surround a dielectric insulator. Housed within these three components is typically a center conductor for transmitting the transmission of signals.

To attach coaxial cables to communications systems, coaxial cables must generally be fitted with end connectors. Various types of end connectors exist for attaching the cables to various types of ports. To attach a connector to a coaxial cable, a preparation process must first be performed whereby a length of the outer jacket is first stripped. Further, the outer metallic conductor may also be required to be cut, and a portion of the dielectric insulator may need to be removed. Preparation jacket cutting tools may be utilized to accomplish these functions. These cutting tools are configured to make a cut at a precise depth around the circumference of the coaxial cable so that the correct components of the coaxial cables are cut. However, because of the precision required, cutting tools are only capable of properly cutting a coaxial cable having an extremely small range of outer diameters. Unfortunately, variations in cable diameter may result from large tolerances or the fact that cables may be provided by different manufacturers. These coaxial cable diameter variations may result in the cable being: (1) too small to be properly stripped by a cutting tool; or (2) too large to fit within the dimensions of a cutting tool.

Accordingly, an adjustable preparation tool for a coaxial cable, and a method of use thereof, would be well received in the art.

### BRIEF DESCRIPTION OF THE INVENTION

According to one aspect, a coaxial cable preparation tool comprises: a body; an cavity extending from the body configured to accommodate insertion of a coaxial cable therein; a blade attached to the body and positionable in the cavity, the blade configured to cut the coaxial cable when the body is rotated with respect to the coaxial cable; and a circumferential adjustment mechanism within the cavity configured to adjust a gripping circumference within the cavity for gripping an outer jacket of the coaxial cable.

According to another aspect, a method of preparing a coaxial cable comprises: inserting the coaxial cable into an cavity of a coaxial cable preparation tool; and adjusting a gripping circumference within the cavity of the coaxial cable preparation tool, wherein the gripping circumference is configured to grip an outer jacket of the coaxial cable, and wherein the adjusting is accomplished by the inserting of the coaxial cable into the cavity.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a perspective view of an adjustable preparation tool in accordance with one embodiment;

FIG. 2 depicts a side view of the adjustable preparation tool of FIG. 1;

FIG. 3 depicts a side view of the adjustable preparation tool of FIGS. 1-2 after rotation;

FIG. 4 depicts a front view of the adjustable preparation tool of FIGS. 1-3;

FIG. 5 depicts a front cutaway view of the adjustable preparation tool of FIGS. 1-4;

FIG. 6 depicts an exploded view of the adjustable preparation tool of FIGS. 1-5;

FIG. 7a depicts a side cross-sectional view of an embodiment of a coaxial cable following preparation;

FIG. 7b depicts a side view of the coaxial cable of FIG. 7a;

FIG. 7c depicts a perspective view of the coaxial cable of FIGS. 7a-7b;

FIG. 8 depicts a cross sectional side view of an adjustable preparation tool according to one embodiment;

FIG. 9 depicts a cross sectional side view of an adjustable preparation tool with an adjustable displacement cap in accordance with one embodiment;

FIG. 10 depicts a cross sectional front view of an adjustable preparation tool in accordance with one embodiment;

FIG. 11 depicts a front view of an adjustable preparation tool in accordance with one embodiment;

FIG. 12 depicts a side view of the adjustable preparation tool of FIG. 11;

FIG. 13 depicts a side cutaway view of an adjustable preparation tool; and

FIG. 14 depicts a front cutaway view of the adjustable preparation tool of FIG. 13.

### DETAILED DESCRIPTION OF THE INVENTION

A detailed description of the hereinafter described embodiments of the disclosed apparatus and method are presented herein by way of exemplification and not limitation with reference to the Figures.

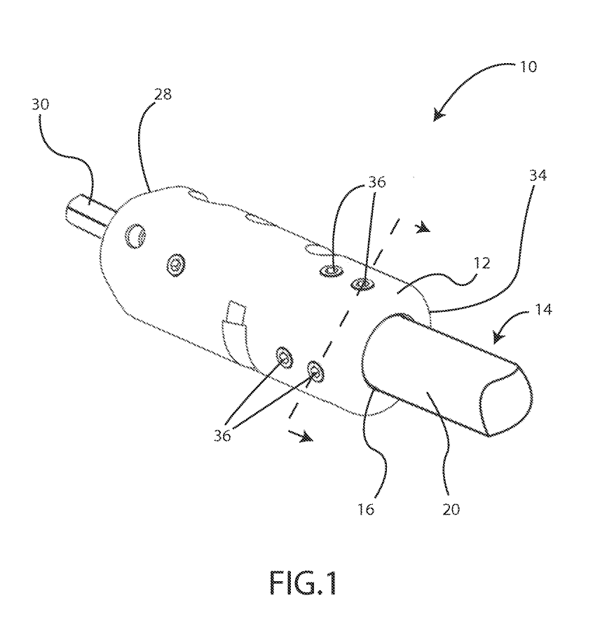

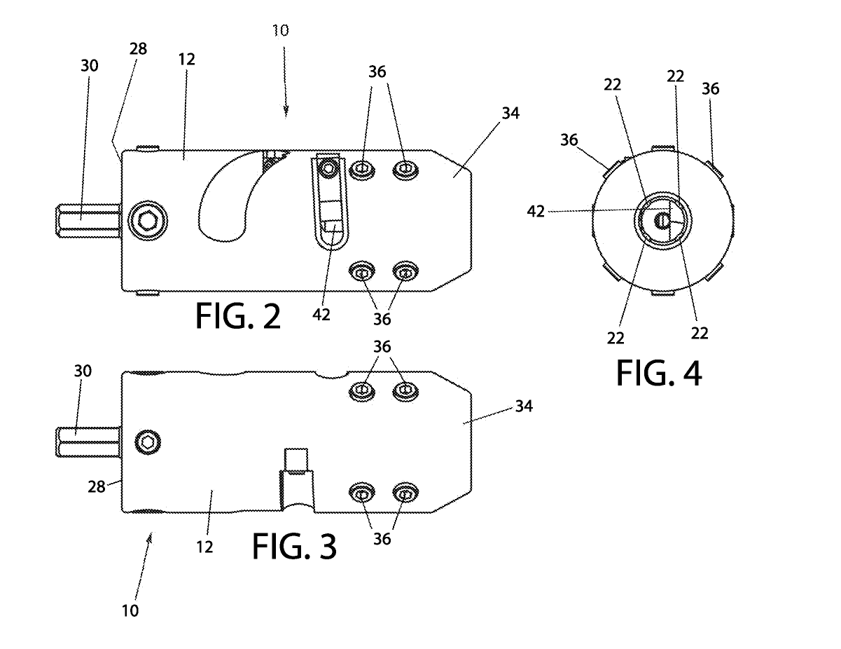

Referring to FIGS. 1-6, an adjustable preparation tool 10 is shown according to one embodiment. The adjustable preparation tool 10 includes a main body 12 configured to receive an end of a coaxial cable 14 within a cavity 16. Once the coaxial cable 14 is received, at least one internal blade 42, 44, 46 within the cavity 16 may be brought into contact and pierce an outer plastic jacket 20 of the coaxial cable 14. The adjustable preparation tool 10 may then be rotated about the coaxial cable 14 in order to make a circumferential cut in the outer plastic jacket 20 for removal during a cable preparation process. Within the adjustable preparation tool 10, a circumferential adjustment mechanism may be provided. In the embodiment shown in FIGS. 1-6, the circumferential adjustment mechanism comprises a plurality of ball bearings 22 biased with springs 24 such that a portion of the ball bearings 22 extend within an inner circumference 22 of the cavity 16. When the outer jacket 20 has a diameter substantially equal to the diameter of the cavity 16 is inserted into the cavity 16, the ball bearings 22 may retract into respective holes 26 that extend radially outwardly from the cavity 16. Alternately, when the outer jacket 20 has a diameter that is less than the diameter of the cavity 16 is inserted into the cavity 16, the ball bearings 22 may be fully biased in the pocket, providing support for the coaxial cable. Thus, the adjustable preparation tool 10 may be configured to receive coaxial cables of varying outer jacket circumferential dimensions.

The main body 12 of the adjustable preparation tool 10 may be substantially cylindrical in shape. However, the main body 12 may also take any shape operable to appropriately prepare a coaxial cable. Extending from a first end 28 of the circumferential adjustment tool 10 may be a post 30 so that the circumferential adjustment tool 10 may be attached with a handle 32 for ease of manual rotation. The post 30 may have a hexagonal or square cross section or the like. The post 30 may also be a drive bit for attachment to a drive socket of an automatic drilling machine. A number of posts 30 may be attachable to the main body 12 for attachment to different drive sockets or handles. It should be understood that the main body 12 may be made of a metallic material, such as steel. Alternately, the main body 12 may be made of a plastic, or a composite or the like. Any material or combination of materials that would offer a sufficient product life may be appropriate. The main body 12 is shown as a single piece of material, such as a fashioned rod. However, in other embodiments contemplated, the main body 12 may be formed of multiple component elements joined or coupled together.

At a second end 34 of the adjustable preparation tool 10 may be the cavity 16. The cavity 16 may also be a hole, bore, gap, opening or the like. The cavity 16 may extend from the second end 34 along a central axis of the main body 12. The cavity 16 may extend an adequate length such that the coaxial cable 14 is insertable a sufficient distance past the internal blade 18. Thus, the eventual cut of the internal blade 18 may be configured to remove the proper length of the outer plastic jacket for preparation of the coaxial cable 14. Furthermore, it should be understood that coaxial cables have many various thicknesses depending on the application. Different embodiments contemplated may have cavities 16 specifically sized to accommodate different types of coaxial cables. However, each embodiment is adjustable such that a range of dimensional tolerances of coaxial cables are receivable in the cavity 16 for proper jacket stripping. Furthermore, embodiments may include multiple cavities

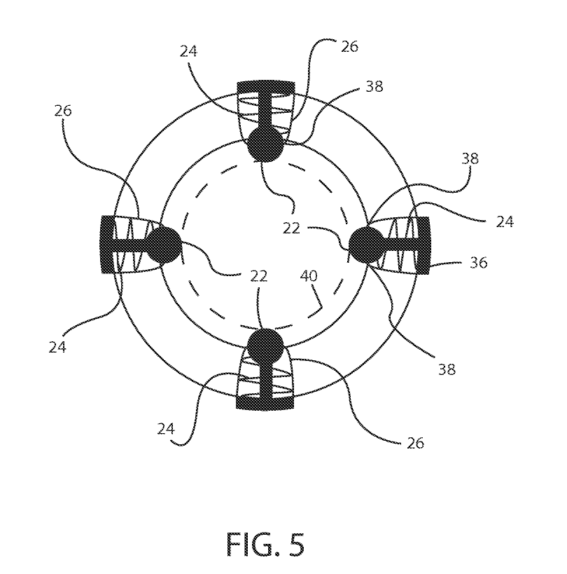

Upon insertion of the coaxial cable 14 into the cavity 16, the outer jacket 20 of the coaxial cable 14 may push the ball bearings 22 back into their respective holes 26. It should be understood that the ball bearings 22 in this embodiment may be any substantially spherical and hard object. The ball bearings 22 are biased by the springs 24 such that they may grip and retain the coaxial cable 14 within the cavity 16. Screw caps 36 hold the springs 24 and ball bearings 22 within this configuration. The holes 26, shown more particularly in FIG. 5, may extend partially through the inner diameter of the main body 12 such that an opening 38 is created between the holes 26 and the cavity 16 of the main body. This opening 38 is where the ball bearings 22 may be configured to stick out of due to the spring bias. The openings 38 may be circular in shape, in one embodiment, and may be between two thirds to one half the diameter of the ball bearings 22 such that a portion of the ball bearing sticks out of the opening 38 into the cavity 16. In one embodiment, about a third of the ball bearing is configured to protrude into the cavity 16. However, other amounts of protrusion are contemplated. Further, the springs 24 may have a spring constant such that the ball bearings 22 are pushed radially inwardly toward the cavity 16 with such a force to allow the ball bearings to sufficiently grip an inserted coaxial cable.

The embodiment shown includes a total of eight ball bearings 22 with eight respective holes 26 and eight screw caps 36. It should be understood that any number of ball bearing and spring combinations are contemplated. It should further be understood that the ball bearings 22 and springs 24 combination may also be replaced by a spring plunger or other element that can be displaced in a similar manner upon insertion of the coaxial cable 14. Two sets of four ball bearings 22 are shown that are co-planar along the center axis of the main body 12. The ball bearings 22 from each set are spread 90 degrees apart about the main body 12. The ball bearings 22 are configured to create a gripping circumference 40 that is less than the inner circumference of the cavity 16. This gripping circumference 40 is thus automatically adjustable to accommodate coaxial cables with jackets having different outer diameters, as described hereinabove. The adjustable preparation tool 10 may thereby accommodate coaxial cables having outer jackets of a minimum outer diameter equal to the gripping circumference 40 when the ball bearings 22 are fully extended into the opening 38. The adjustable preparation tool 10 may thereby further accommodate coaxial cables having outer jackets of a maximum outer diameter equal to the inner circumference of the cavity 16.

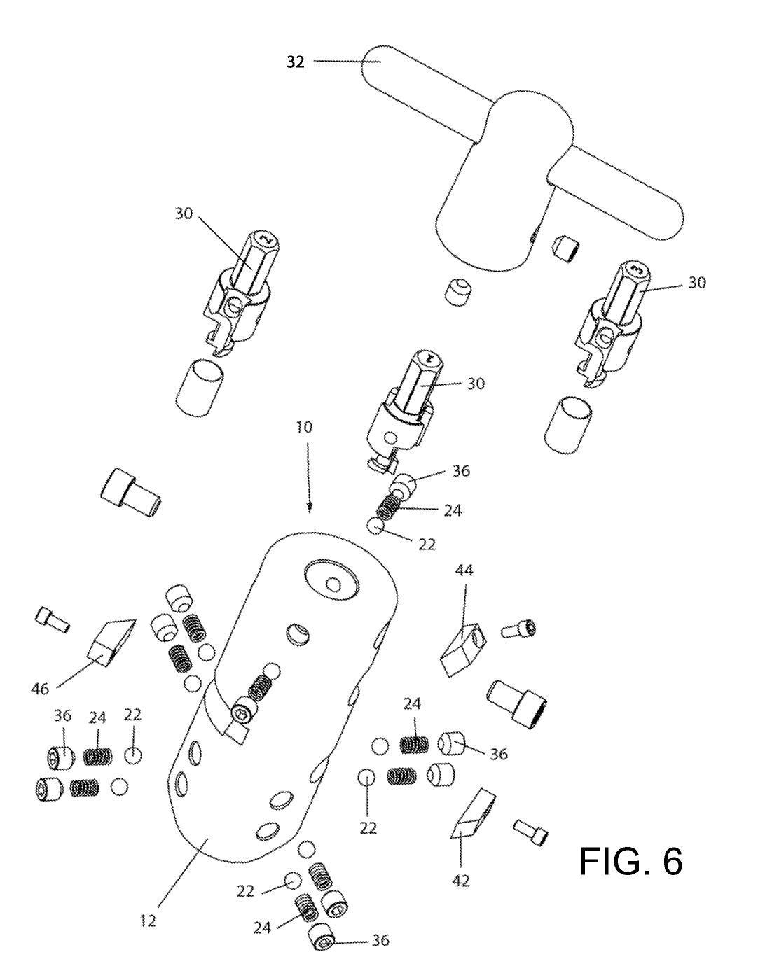

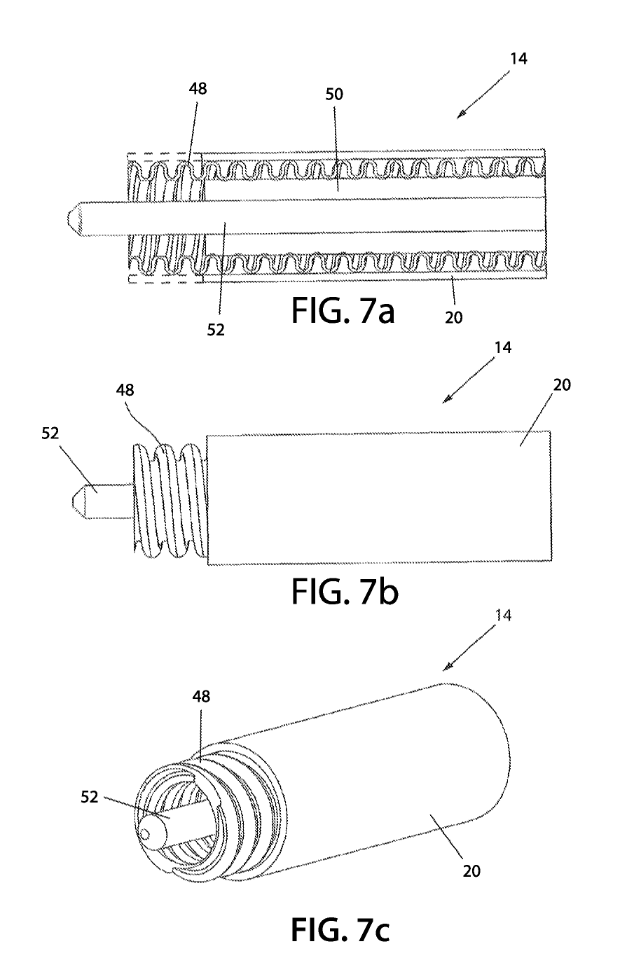

Referring particularly to exploded view shown in FIG. 6, the adjustable preparation tool 10 includes one or more blades 42, 44, 46 for cutting the various components of the coaxial cable 14. For example, a first and second cutter 42, 44 may be configured to strip the outer plastic jacket 20 of the coaxial cable 14. A third blade 46 may be configured to cut an outer conductor 48 (shown in FIGS. 7a-7c) of the coaxial cable 14. These blades 42, 44, 46 may be movable with respect to the main body 12 in order to allow the coaxial cable to be inserted into the cavity 16 without interference. Once inserted, one or more of the blades 42, 44, 46 may be brought into contact and pierce the coaxial cable 14. The blades 42, 44, 46 may be movable with respect to the inserted coaxial cable 14 with a lever, toggle, actuator or the like (not shown). Thereafter, the adjustable preparation tool 10 may be rotated in order to cut the components of the coaxial cable 14. Again, rotation may be actuated by hand turning the adjustable preparation tool 10, or by turning the device automatically with a drill. The blades 42, 44, 46 may each be located within the cavity 16 the preparation process. However, in alternate embodiments, the adjustable preparation tool 10 may include a plurality of openings or cavities for performing different cuts or preparation stages on the coaxial cable 14. Different cutting tools, stripping blades, coring blades, and the like, may be located in different openings of the adjustable preparation tool 10.

Referring now to FIG. 7a-c, the coaxial cable 14 is shown after being prepared by the adjustable preparation tool 10. The coaxial cable 14 includes an outer jacket 20. The outer jacket 20 may be made of plastic, or other appropriate insulator. The outer jacket 20 surrounds the outer conductor 48 or metallic shield. The principles defined herein would extend to applications involving multi-outer conductor cables. Both the outer conductor 48 and the outer jacket 20 may further surround a dielectric insulator 50. Housed within these three components may be a center conductor 52 for the transmission of signals. While the coaxial cable 14 shown in the Figures has a spiral walled outer conductor, it should be understood that the adjustable preparation tools described herein may be applicable for preparing any types of coaxial cables. For example, a smooth walled outer conductor cable, an annular corrugated cable, or a braided outer cable may be prepared. It should be understood that some coaxial cables 14 may include a plurality of outer conductors. The adjustable preparation tool described herein would be useful in gripping and holding the jacket of any coaxial cable during preparation. It should be understood that preparation of the coaxial cable 14 may include removing a length of the outer jacket 20 and a lesser length of the outer conductor 48. Further, the preparation may include coring the dielectric insulator 50. Still further, preparation may include chamfering the tip of the center conductor 52. These preparation steps may be accomplished with the blades 42, 44, 46 within the cavity 16.

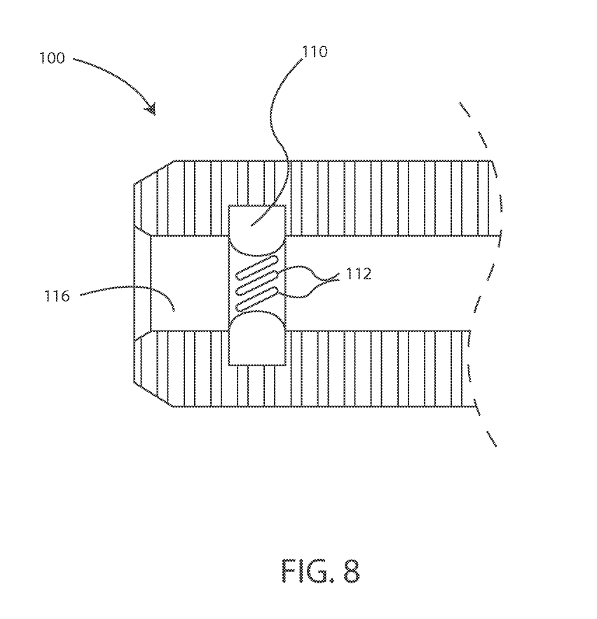

Referring now to FIG. 8, a cross sectional side view of an adjustable preparation tool 100 is shown. The adjustable preparation tool 100 includes a cavity 116. The adjustable preparation tool 100 may be similar to the adjustable preparation tool 10 described herein above except that the circumferential adjustment mechanism in this embodiment may be an elastomeric donut 110. The elastomeric donut 110 may be displaceable for coaxial cables having wider circumferences. Yet, for coaxial cables having relatively smaller circumferences, the elastomeric donut 110 may still hold the coaxial cable in the appropriate position to achieve proper cutting. The elastomeric donut 110 may include patches 112 of a slippery material such as Teflon, polyethylene or the like. The patches 112 may allow the rubber to spin or slide against the coaxial cable without sticking or seizing. Thus, the gripping circumference of the cavity 116 is adjustable with the elastomeric donut. Insertion of a coaxial cable into the cavity 116 alters the gripping circumference of the cavity 116.

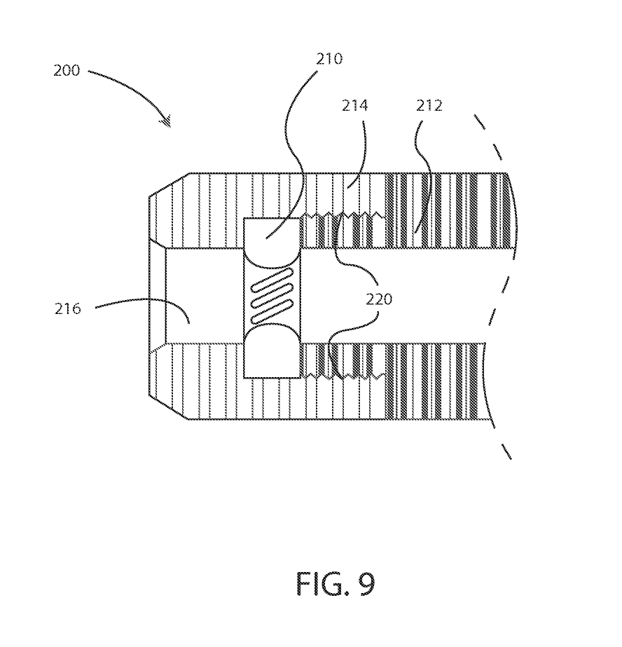

With reference to FIG. 9, a cross sectional side view of another adjustable preparation tool 200 is shown. The adjustable preparation tool 200 includes a cavity 216 with an elastomeric donut 210 similar to the embodiment described with respect to FIG. 8. However, in this embodiment, a main body 212 includes a cap portion 214. The main body 212 and cap portion 214 may include respective threads 220 for engagement with each other. Thus, the cap portion 214 may be turned with respect to the main body 212 to compress the elastomeric donut 210 and reduce the gripping circumference. The amount that the cap 214 is screwed onto the main body 212, the elastomeric donut may thereby allow the adjustable penetration tool 200 to better accommodate coaxial cables of different circumferences. While the embodiment in FIG. 9 includes threads to move the cap 214 relative the main body 212, other embodiments utilizing an elastomeric donut are contemplated. For example, the main body 212 may slidably move with respect to the cap portion 214. A locking mechanism may then lock the cap 214 and main body 212 into place.

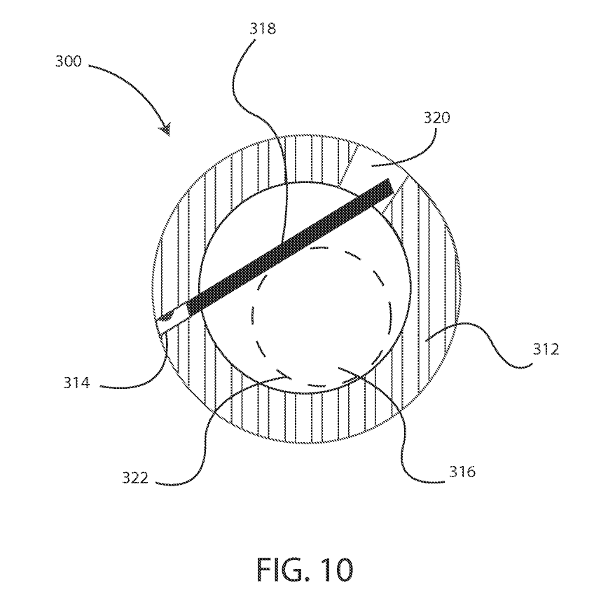

FIG. 10 shows a front cutaway view of another embodiment of an adjustable preparation tool 300. The adjustable preparation tool 300 includes a main body 312 and a cavity 316. It should be understood that the cavity 316, main body 312 of the adjustable preparation tool 300 may be similar to the cavity 16, main body 12 of the adjustable preparation tool 10. In this embodiment however, a substantially tangential hole 314 may extend through the main body 312 into the cavity 316. A wire 318 or other semi-rigid member may be press fit into a first hole 314 such that it extends into a cavity 316. A corresponding slot 320 also extends through the main body 312 into the cavity 316. This slot 320 may be wider than the narrow hole 314. The wire 318 may flex into the slot 320 to expand a gripping circumference 322 within the cavity 316. The flex of the wire 318 thereby allows the adjustable preparation tool 300 to accommodate coaxial cables having varying outer diameters.

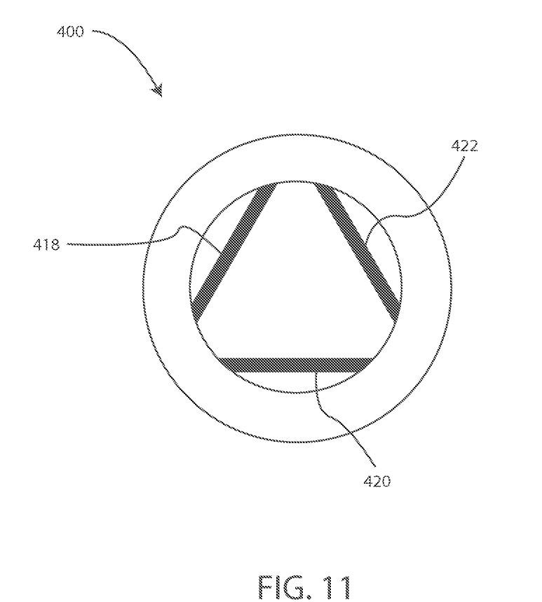

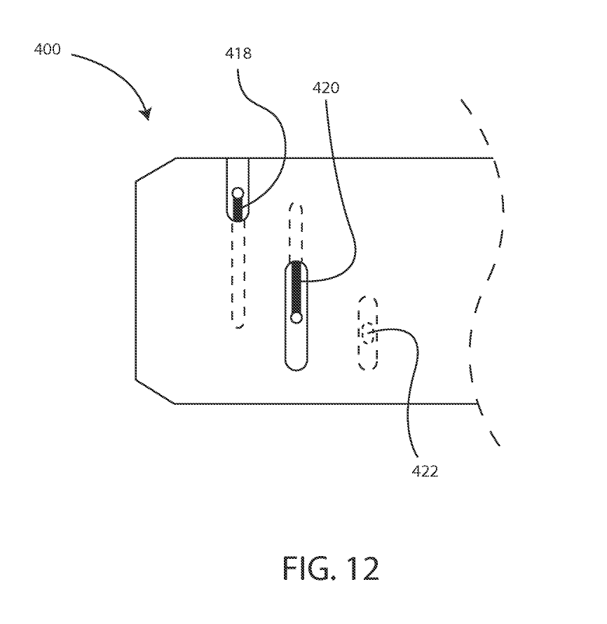

Referring to FIGS. 11-12, another embodiment of an adjustable preparation tool 400 is shown. This embodiment is substantially similar to the embodiment described hereinabove with respect to FIG. 10. However, in this embodiment, more than one wire 418, 420, 422 is used to create a balanced centering force on an inserted coaxial cable (not shown). While this embodiment shows three wires 418, 420, 422, other embodiments are contemplated that utilize two wires or more than three wires. The wires 418, 420, 422 may include respective holes and slots like the embodiment shown in FIG. 10. Moreover, the wires 418, 420, 422 may be staggered lengthwise along the center axis of the adjustable preparation tool 400 in order to avoid interference, as shown in FIG. 12.

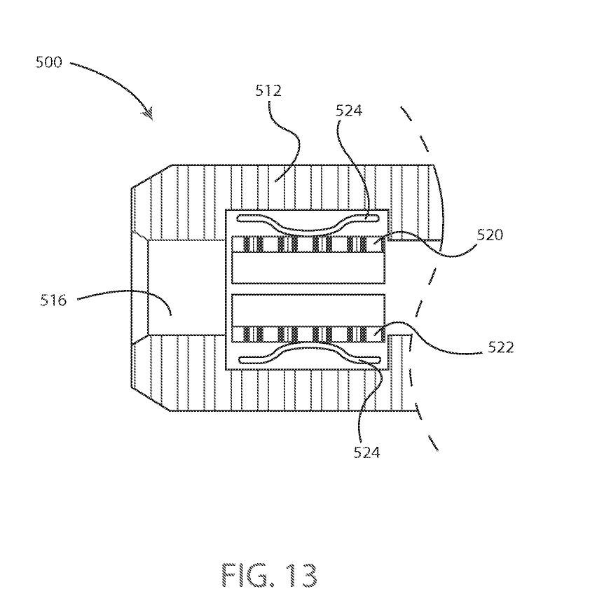

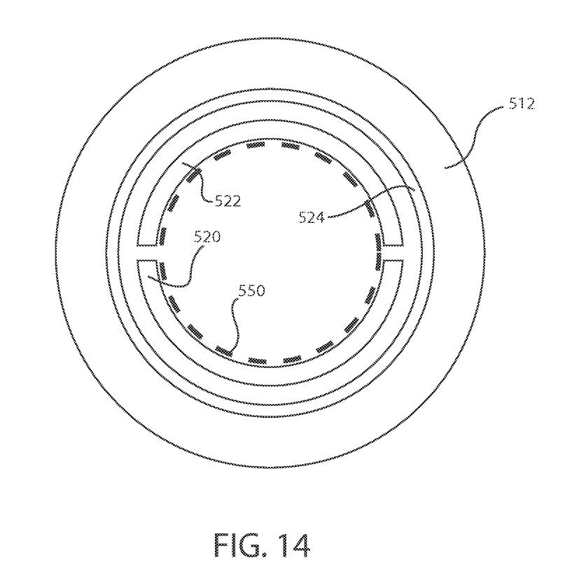

With reference to FIGS. 13-14, a further embodiment of an adjustable preparation tool 500 is shown. Like the previous embodiments, the adjustable preparation tool 500 includes a main body 512 and a cavity 516. However, in this embodiment, the adjustable preparation tool 500 includes two jaws 520, 522. The jaws 520, 522 combine to form an inner gripping circumference 550. Between the jaws 520, 522 and the main body 512 is circumferential stamped metal portion 524. The stamped metal portion 524 acts as a spring so that the jaws 520, 522 expand when subjected to pressure from the outer circumference of a coaxial cable (not shown). While the embodiment depicted in the Figures includes two jaws, it should be understood that more than two jaws may be utilized. Further, the stamped portions 520, 522 may not be metal, but may instead be plastic, or another semi-rigid, semi-flexible material that allows the jaws to expand with the insertion of a coaxial cable.

A method of preparing a coaxial cable, such as the coaxial cable 14, is also contemplated. The method may first include inserting the coaxial cable into a cavity, such as the cavity 16 of an adjustable preparation tool, such as the adjustable preparation tool 10. Further, the method may include adjusting a gripping circumference within the cavity of the coaxial cable preparation tool. The gripping circumference may be configured to grip the outer jacket of the coaxial cable. Further, the adjusting may accomplished by the inserting of the coaxial cable into the cavity. The method may then include rotating the main body of the adjustable preparation tool. The method may include stripping an outer jacket of an inserted coaxial cable with a blade of the adjustable preparation tool. The method may still further include preparing the coaxial cable with the adjustable preparation tool.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. A coaxial cable preparation tool comprising:
a body;
a cavity extending from the body configured to accommodate insertion of a coaxial cable therein;
a blade attached to the body and positionable in the cavity, the blade configured to cut the coaxial cable when the body is rotated with respect to the coaxial cable; and
a circumferential adjustment mechanism within the cavity configured to adjust a gripping circumference within the cavity for gripping an outer jacket of the coaxial cable.

2. The coaxial cable preparation tool of claim 1, wherein the circumferential adjustment mechanism comprises a plurality of ball bearings biased with springs such that the a portion of each of the ball bearings extends within the cavity.

3. The coaxial cable preparation tool of claim 2, wherein each of the plurality of ball bearings is configured to retract into respective holes that extend radially outwardly from the cavity into the body.

4. The coaxial cable preparation tool of claim 2, wherein each of the plurality of ball bearings is biased by springs such that the combination of ball bearings grips and retains an inserted coaxial cable.

5. The coaxial cable preparation tool of claim 4, wherein the springs each have a spring constant such that the ball bearings are pushed radially inwardly toward the cavity with such a force to allow each of the plurality of ball bearings to sufficiently grip the inserted coaxial cable.

6. The coaxial cable preparation tool of claim 2, wherein each of the plurality of ball bearings is biased by a spring plunger such that the combination of ball bearings grips and retains an inserted coaxial cable.

7. The coaxial cable preparation tool of claim 1, wherein the circumferential adjustment mechanism comprises an elastomeric donut.

8. The coaxial cable preparation tool of claim 7, wherein the elastomeric donut includes a patch of a slippery material configured to allow the elastomeric donut to slide against a coaxial cable without seizing.

9. The coaxial cable preparation tool of claim 8, wherein the slippery material is selected from the group consisting of Teflon and polyethylene.

10. The coaxial cable preparation tool of claim 8, further comprising a cap portion configured to turn with respect to the body to compress the elastomeric donut and reduce the gripping circumference.

11. The coaxial cable preparation tool of claim 1, wherein the circumferential adjustment mechanism comprises at least one wire that is configured to flex in order to expand the gripping circumference within the cavity.

12. A method of preparing a coaxial cable, the method comprising:
inserting the coaxial cable into a cavity of a coaxial cable preparation tool; and
adjusting a gripping circumference within the cavity of the coaxial cable preparation tool, wherein the gripping circumference is configured to grip an outer jacket of the coaxial cable, and wherein the adjusting is accomplished by the inserting of the coaxial cable into the cavity.

13. The method according to claim 12, further comprising rotating the main body of the adjustable preparation tool.

14. The method according to claim 12, further comprising stripping an outer jacket of the inserted coaxial cable with a blade of the adjustable preparation tool.

15. The method according to claim 12, further comprising preparing the coaxial cable with the adjustable preparation tool.

16. A coaxial cable preparation tool comprising:
a body;
a cavity extending from the body configured to accommodate insertion of a coaxial cable therein;
a blade attached to the body and positionable in the cavity, the blade configured to cut the coaxial cable when the body is rotated with respect to the coaxial cable; and
a means for adjusting the circumference of a gripping surface within the cavity for gripping an outer jacket of the coaxial cable.

17. The coaxial cable preparation tool of claim 16, wherein the means for adjusting the circumference of the gripping surface within the cavity is a plurality of ball bearings biased with springs such that the a portion of each of the ball bearings extends within the cavity.

18. The coaxial cable preparation tool of claim 17, wherein each of the plurality of ball bearings is configured to retract into respective holes that extend radially outwardly from the cavity into the body.

19. The coaxial cable preparation tool of claim 16, wherein the means for adjusting the circumference of the gripping surface within the cavity is an elastomeric donut.

20. The coaxial cable preparation tool of claim 16, wherein the means for adjusting the circumference of the gripping surface within the cavity is at least one wire that is configured to flex in order to expand the gripping circumference within the cavity.
